(19) United States
(12) Patent Application Publication
(10) Pub. No.: US 2016/0026222 A1
(43) Pub. Date: Jan. 28, 2016

(54) PROTECTIVE PLATE AND PREPARATION METHOD THEREOF, DISPLAY PANEL AND DISPLAY DEVICE

(71) Applicant: BOE TECHNOLOGY GROUP CO., LTD., Beijing (CN)

(72) Inventors: Wei DENG, Beijing (CN); Zhuo ZHANG, Beijing (CN); Yinglong HUANG, Beijing (CN); Guanbao HUI, Beijing (CN)

(21) Appl. No.: 14/429,910

(22) PCT Filed: Jun. 20, 2014
(86) PCT No.: PCT/CN2014/080456

§ 371 Date: Mar. 20, 2015

(30) Foreign Application Priority Data
Jan. 29, 2014 (CN) 201410043332.8

(51) Int. Cl. G06F 1/16; G06F 3/041

(52) U.S. Cl. CPC G06F 1/1656; G06F 3/041; G06F 1/1637

(57) ABSTRACT

A protective plate and a preparation method thereof, a display panel and a display device. The protective plate comprises a translucent substrate, wherein a white shading frame, for covering a circuit layer, is provided in a periphery of the translucent substrate. In this way, it is possible to make a non-display region of the display panel be white.

### TECHNICAL FIELD

Embodiments of the invention relate to a protective plate and a preparation method thereof, a display panel and a display device.

### BACKGROUND

Currently, electronics devices such as smart phones, tablet computers and so on in the market mainly have black frames. However, with diversified development of the electronic devices, white smart phones or tablet computers and the like are more and more welcomed to consumers, especially young ladies.

Integrated circuits of a display panel of an electronic device are mainly set in a non-display region in a periphery of the display panel; in order not to affect the appearance, typically these circuits are covered by using a black opaque material, thereby forming a black non-display region.

The electronic devices such as white smart phones or tablet computers often just have white outer cases, while the non-display regions of their display panels are black. In this way, a contrast between the white outer cases and the black non-display regions are too sharp, affecting the appearance. Therefore, there is an urgent need to design a white non-display region, to manufacture the white smart phones or tablet computers and other electronic devices with outer cases and non-display regions in a same color.

### SUMMARY OF THE INVENTION

The embodiments of the invention provide a protective plate, comprising a translucent substrate. A white shading frame, for covering a circuit layer, is provided in a periphery of the translucent substrate.

For example, the protective plate further comprises an optical transparent layer, which is arranged on the translucent substrate provided with the white shading frame, with a height of the optical transparent layer over the white shading frame less than a height of the optical transparent layer over the translucent substrate.

For example, a thickness of the white shading frame is 5-20 μm; the height of the optical transparent layer over the white shading frame is 1-5 μm; and the height of the optical transparent layer over the translucent substrate is 6-25 μm.

For example, the thickness of the white shading frame is 8-12 μm; the height of the optical transparent layer over the white shading frame is 1-3 μm; and the height of the optical transparent layer over the translucent substrate is 8-15 μm.

For example, the optical transparent layer is made of a translucent polymer material.

For example, the translucent polymer material is an optical clear resin.

For example, the white shading frame is made of an opaque polymer material.

For example, the opaque polymer material is a white photosensitive ink.

For example, a groove is further provided in the periphery of the translucent substrate, and the white shading frame is arranged above the groove.

An embodiment of the present invention further provides a display panel, comprising any of the above described protective plates.

An embodiment of the present invention further provides a display device, comprising any of the above described display panels.

An embodiment of the present invention further provides a preparation method of a protective plate, comprising: providing a translucent substrate; and forming a white shading frame, for covering a circuit layer, in a periphery of the translucent substrate.

For example, after forming of a white shading frame in a periphery of the translucent substrate, the method further comprises: forming an optical transparent on the translucent substrate provided with the white shading frame, with a height of the optical transparent layer over the white shading frame less than a height of the optical transparent layer over the translucent substrate.

For example, forming of a white shading frame in a periphery of the translucent substrate comprises: forming a white shading frame in the periphery of the translucent substrate by screen printing, or by transferring or spin coating as well as exposing and developing; and forming of an optical transparent layer on the translucent substrate provided with the white shading frame comprises: forming an optical transparent layer on the translucent substrate provided with the white shading frame by spin coating or blade coating.

For example, after the providing a translucent substrate, the method further comprises: forming a groove in the periphery of the translucent substrate; forming of a white shading frame in a periphery of the translucent substrate comprises: forming a white shading frame above the groove.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a lateral sectional view of a protective plate provided by an embodiment of the present invention;

FIG. 2 is a plan view of the protective plate shown in FIG. 1;

FIG. 3 is a lateral sectional view of another protective plate provided by an embodiment of the present invention; and

FIG. 4 is a lateral sectional view of a display panel of the protective plate provided by the embodiment of the present invention as shown in FIG. 1.

### DESCRIPTION OF THE EMBODIMENTS

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

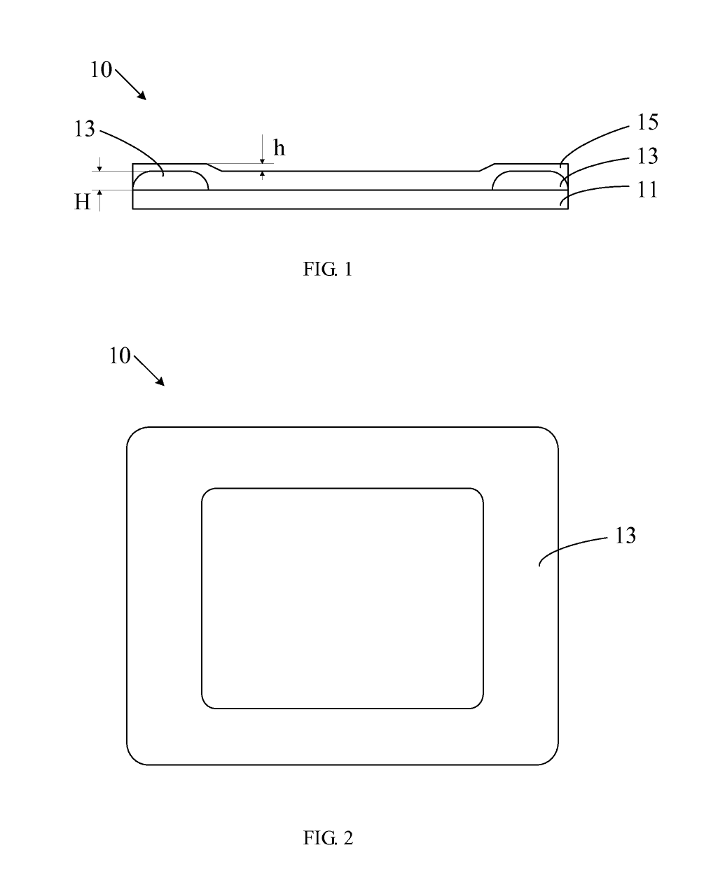

As shown in FIG. 1 and FIG. 2, an embodiment of the present invention provides a protective plate 10, comprising a translucent substrate 11, and a white shading frame 13, for covering a circuit layer (not shown), is provided in a periphery of the translucent substrate 11.

In the protective plate 10 provided by the embodiment of the present invention, the white shading frame 13 is provided in the periphery of the translucent substrate 11, so as to cover the integrated circuits and other circuit layers disposed in the periphery of the display panel, which improves an aesthetic feeling of the display panel; since the white shading frame 13 is in a white color, it will form a white non-display region, so when the outer case of an electronic device using the protective plate 10 is also white, the periphery of the entire electronic device will be white, i.e., a white electronic device which has an outer case and non-display region in a same color is formed.

As shown in FIG. 1, the protective plate 10 may further comprise an optical transparent layer 15, which is arranged on the translucent substrate 11 provided with the white shading frame 13, with the height of the optical transparent layer 15 over the white shading frame 13 being less than the height of the optical transparent layer 15 over the translucent substrate 11.

Thus, since the height of the optical transparent layer 15 over the white shading frame 13 is less than the height of the optical transparent layer 15 over the translucent substrate 11, a surface height difference over the protective plate 10 can be effectively reduced or eliminated, i.e., the surface height difference is reduced from H to h, or disappears (h=0), thus facilitating a fabrication of a sensor layer desired by a touch screen on the optical transparent layer 15, such as sputtering an ITO conductive layer, coating a metal mesh layer, etc., so that the protective plate 10 is applicable to a one-glass-solution (OGS) technology.

It should be noted that the so-called OGS technology refers to that integrating the touch screen and the protective plate, that is, the coating and photo-lithography can be directly implemented on the protective plate, to sputter the ITO conductive layer or coat the metal mesh layer on the protective plate. As compared with technologies of separately bonding the protective plate and the touch screen, and the touch screen and the display screen, the OGS technology saves one piece of glass and one bonding process, and therefore, the OGS technology can make the touch screen much thinner and cheaper.

For example, in the protective plate 10 provided by the embodiment of the present invention, the translucent substrate 11 is made of a translucent material, such as glass or transparent plastic, that is, the translucent substrate 11 may be a substrate commonly used in the related technical field, mainly for protecting the touch screen and the display screen inside the display panel, which is not limited by the embodiment of the present invention.

The white shading frame 13 is made of a white opaque material, which may be an opaque inorganic non-metallic material such as ceramic, or an opaque polymer material, such as white screen printing ink, white photosensitive ink, or high-temperature resistant white photosensitive ink, photoresist, etc., so that the white shading frame 13 can be seamlessly bonded to the periphery of the translucent substrate 11.

A thickness H of the white shading frame is 5˜20 μm, further 8˜12 μm. For example, the thickness H of the white shading frame 13 can be 5 μm, 6 μm, 8 μm, 10 μm, 12 μm, 14 μm, 16 μm, 18 μm, or 20 μm. Thus, even when the white shading frame 13 is made of high-temperature resistant white photosensitive ink, it is possible to sufficiently shield the light, to form the white non-display region in the periphery of the translucent substrate 11. For example, in this embodiment of the present invention, the white shading frame 13 is made of high-temperature resistant white photosensitive ink, the thickness H is 12 μm, and when it is cured under the irradiation of ultraviolet light, a white non-display region will be formed.

The optical transparent layer 15 is made of a translucent material, which can be a translucent inorganic non-metallic material, such as glass, or a translucent polymer material, for example, a glue of high transparency, weatherability, and good lightfastness, such as an optical clear (OC) resin, so that it can be more easily provided on the translucent substrate 11 having the white shading frame 13, to more easily control its heights over the white shading frame 13 and over the translucent substrate 11. For example, a layer of OC resin can be coated on the translucent substrate 11 provided with the white shading frame 13 by spin coating or blade coating, and an amount of OC resin on the white shading frame 13 and the translucent substrate 11 is appropriately controlled, then desired heights can be obtained after curing through light-exposure.

For example, the height of the optical transparent layer 15 over the white shading frame 13 can be 1-5 μm, and further can be 1-3 μm. For example, the height of the optical transparent layer 15 over the white shading frame 13 can be 1 μm, 2 μm, 3 μm, 4 μm, or 5 μm. The height of the optical transparent layer 15 over the translucent substrate 11 can be 6-25 μm, and further can be 8-15 μm. For example, the height of the optical transparent layer 15 above the translucent substrate 11 can be 6 μm, 7 μm, 8 μm, 9 μm, 11 μm, 13 μm, 15 μm, 18 μm, 22 μm, or 25 μm. In summary, as long as the height of optical transparent layer 15 over the white shading frame 13 is less than the height of optical transparent layer 15 over translucent substrate 11, a person of skill in the art can select an appropriate range of values according to the actual situation, which will not be limited in the embodiment of the present invention.

Thus, the surface height difference of the protective plate 10 can be reduced from H to h, or completely eliminated (i.e., h=0), thereby facilitating the fabrication of the sensor layer desired by the touch screen on the substrate, such as sputtering an ITO conductive layer, coating a metal mesh layer, etc., so that the protective plate 10 is applicable to the OGS technology. That is, the protective plate 10 provided by the embodiment of the present invention provides the OGS technology with a technical solution of making a white non-display region, which can facilitate manufacturing electronic devices such as white smart phones or tablet computers with outer cases and non-display regions in a same color.

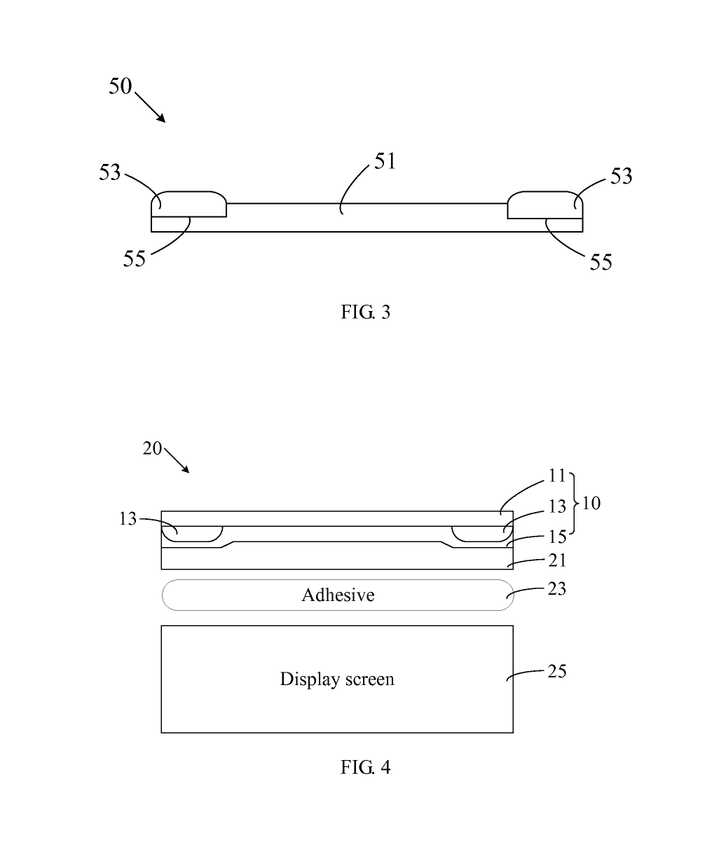

FIG. 3 is another protective plate 50 provided by an embodiment of the present invention, comprising a translucent substrate 51, having a groove 55 provided in a periphery of the translucent substrate 51, and a white shading frame 53 on the groove 55. In this way, since the groove 55 is provided in the translucent substrate 51, after the white shading frame 53 is arranged on the groove 55, a surface height difference of the protective plate 50 is effectively reduced.

The depth of the groove 55 can be set according to a thickness of the translucent substrate 51. For example, if the translucent substrate 51 is relatively thick, then it may be deeper; if the translucent substrate 51 is relatively thin, then it may be shallower. For example, the depth of the groove 55 can be 1˜10 μm. For example, the depth of the groove 55 can be 1 μm, 2 μm, 4 μm, 6 μm, 8 μm or 10 μm. The shape of the groove 55 is shown in FIG. 3, or it may be in any other shape, as long as the thickness of the substrate with the white shading frame 53 is less than the thickness of substrate without the white shading frame 53, which will not be limited by the embodiment of the present invention.

It should be noted that in the protective plate 50 provided by the embodiment of the present invention, the material and thickness of the translucent substrate 51 and the white shading frame 53, can be each the same as the material and thickness of the translucent substrate 11 and the white shading frame 13 in the above-described embodiment, which will not be described in detail here.

It should be further noted that when the height of white shading frame 53 is equal to the depth of the groove 55, the surface height difference of the protective plate 50 can even disappear.

Thus, the protective plate 50 provided by the embodiment of the present invention requires a simple process, and due to the design of the groove, the surface height difference of the protective plate 50 can be reduced or eliminated, i.e., it is ensured that the white shading frame 53 is thick enough to fully shield the light, while the surface height difference of the protective plate 50 is effectively reduced or eliminated, thereby facilitating a fabrication of a sensor layer desired by a touch screen on the protective plate 50, such as sputtering an ITO conductive layer, applying a metal mesh layer, etc., so that the protective plate 50 is applicable to the OGS technology.

An embodiment of the present invention further provides a display panel, comprising any protective plate provided by the embodiments of the present invention. The display panel can achieve all technical effects of the protective plate, which will not be repeated here.

For example, FIG. 4 is a lateral sectional view of a display panel 20 formed by the OGS technology. The display panel 20 comprises the protective plate 10 provided by the embodiment of the present invention, a sensor layer 21 integrated with the protective plate 10, and a display screen 25; the sensor layer 21 integrated with the protective plate 10 is bonded with the display screen 25 via an adhesive 23. It should be noted that the integration of the protective plate 10 and the sensor layer 21 is to integrate protective glass with a touch screen, thus saving a glass substrate required by the sensor layer of the touch screen as well as a bonding process between the protective glass and the touch screen, so as to make the display panel thinner and cheaper.

An embodiment of the present invention further provides a display device, comprising any display panel provided by the embodiments of the present invention. The display device can achieve all technical effects of the display panel, which will not be repeated here.

The display device can be any electronic device with a display function, such as a smart phone, a tablet computer, a music player, an e-book, a laptop and so on.

An embodiment of the present invention further provides a preparation method of a protective plate, which can be used to manufacture any protective plate provided by the embodiments of the present invention. For example, the method comprises the following steps:

S1: providing a translucent substrate;

S2: forming a white shading frame, for covering a circuit layer, in a periphery of the translucent substrate.

For example, after step S2, the method further comprises the following step:

S3: forming an optical transparent layer on the translucent substrate provided with the white shading frame, with a height of the optical transparent layer over the white shading frame less than a height of the optical transparent layer over the translucent substrate.

For example, a thickness of the white shading frame can be 5-20 μm, and further can be 8˜12 μm. For example, the thickness of the white shading frame can be 5 μm, 6 μm, 8 μm, 10 μm, 12 μm, 14 μm, 16 μm, 18 μm, or 20 μm. For example, the height of the optical transparent layer over the white shading frame can be 1-5 μm, and further can be 1-3 μm. For example, the height of the optical transparent layer over the white shading frame can be 1 μm, 2 μm, 3 μm, 4 μm, or 5 μm. The height of the optical transparent layer over the translucent substrate 25 can be 6-15 μm, and further can be 8-15 μm. For example, the height of the optical transparent layer over the translucent substrate can be 6 μm, 7 μm, 8 μm, 9 μm, 11 μm, 13 μm, 15 μm, 18 μm, 22 μm, or 25 μm.

For example, step S2 of forming a white shading frame on the translucent substrate comprises the following step:

S11: forming a white shading frame in the periphery of the translucent substrate by screen printing, or by transferring or spin coating as well as exposing and developing.

For example, step S3 of forming an optical transparent layer on the translucent substrate provided with the white shading frame comprises the following step:

S12: forming an optical transparent layer on the translucent substrate provided with the white shading frame by spin coating or blade coating.

For example, the optical transparent layer is made of a translucent polymer material.

For example, the translucent polymer material is an optical clear resin.

For example, the above step S12 can be conducted as follows:

Enough optical clear resin is coated on the translucent substrate provided with the white shading frame by spin coating or blade coating and cured by full exposure, and a height of the optical clear over the white shading frame is less than a height of the optical clear over the translucent substrate, forming an optical transparent layer with a small surface height difference. Of course, coating and curing by exposure can be performed for multiple times to obtain an optical transparent layer with a desired surface height difference.

In this way, the optical transparent layer effectively reduce or eliminate the height difference between the white shading frame and the translucent substrate, thereby facilitating the fabrication of a sensor layer desired for a touch screen thereon, such as sputtering an ITO conductive layer, coating a metal mesh layer, etc., so that the protective plate is applicable to the OGS technology.

For example, the white shading frame is made of an opaque polymer material.

For example, the opaque polymer material is made of white photosensitive ink, and further, it can be made of high-temperature resistant white photosensitive ink.

For example, after step S1, the method further comprises: forming a groove in the periphery of the translucent substrate.

In this case, step S2 of forming a white shading frame in a periphery of the translucent substrate comprises: forming a white shading frame above the groove.

For example, the groove can be prepared by an engraving technique with an engraving machine or chemical corrosion on the translucent substrate. In summary, as long as the groove can be formed, a person of skill in the art can make choice in accordance with the actual needs, which will not be described in detail in the embodiment of the present invention.

The depth of the groove can be set according to a thickness of the translucent substrate. For example, if the translucent substrate is relatively thick, then it may be deeper; if the translucent substrate is relatively thin, then it may be shallower. For example, the depth of the groove can be 1˜10 μm, and further may be 1 μm, 2 μm, 4 μm, 6 μm, 8 μm or 10 μm.

The preparation method, thickness and material of white shading frame can be selected same as the above described embodiments, which will not be repeated here.

It should be noted that the screen printing, transferring or spin coating as well as exposing and developing, spin coating or blade coating involved in the embodiments of the present invention, are the commonly used methods by a person of skill in the art to prepare films, which will not be described in detail herein.

In order to better illustrate the embodiments of the present invention, the protective plate provided by the embodiment of the present invention is described in detail with examples as follows.

### Example 1

A protective plate, comprises a glass substrate, which is coated with high-temperature resistant white photosensitive ink in its periphery by screen printing, to form a white shading frame with a thickness of 15 μm, for covering a circuit layer; an optical clear is spin-coated on the glass substrate provided with the white shading frame, for curing by full exposure, to form an optical transparent layer with a small surface height difference; a height of the optical transparent layer over the white shading frame is 2 μm; and a height of the optical transparent layer over the translucent substrate is 15 μm.

### Example 2

A protective plate, comprises a glass substrate, which is coated with high-temperature resistant white photosensitive ink in its periphery by screen printing, for exposing and developing, to form a white shading frame with a thickness of 10 μm, for covering a circuit layer; an optical clear resin is spin-coated on the glass substrate provided with the white shading frame, for curing by full exposure, to form an optical transparent layer with a small surface height difference; a height of the optical transparent layer over the white shading frame is 1 μm; and a height of the optical transparent layer over the translucent substrate is 12 μm.

### Example 3

A protective plate, comprises a glass substrate, which is coated with high-temperature resistant white photosensitive ink in its periphery by spin coating, for exposing and developing, to form a white shading frame with a thickness of 12 μm, for covering a circuit layer; an optical clear is spin-coated on the glass substrate provided with the white shading frame, for curing by full exposure, to form an optical transparent layer with a small surface height difference; a height of the optical transparent layer over the white shading frame is 3 μm; and a height of the optical transparent layer over the translucent substrate is 13 μm.

### Example 4

A protective plate, comprises a glass substrate, which is coated with high-temperature resistant white photosensitive ink in its periphery by blade coating, for exposing and developing, to form a white shading frame with a thickness of 20 μm, for covering a circuit layer; an optical clear is blade-coated on the glass substrate provided with the white shading frame, for curing by full exposure, then a layer of optical clear is re-coated, for curing by full exposure, to form an optical transparent layer with a small surface height difference; a height of the optical transparent layer over the white shading frame is 5 μm; and a height of the optical transparent layer over the translucent substrate is 22 μm.

### Example 5

A protective plate, comprises a glass substrate, having a groove with a depth of 8 μm formed in a periphery thereof by chemical corrosion, and high-temperature resistant white photosensitive ink is coated on the groove by screen printing, to form a white shading frame with a thickness of 10 μm, for covering a circuit layer.

The foregoing embodiments merely are exemplary embodiments of the invention, and not intended to define the scope of the invention, and the scope of the invention is determined by the appended claims.

### CROSS REFERENCE TO RELATED APPLICATIONS

The present application claims priority of Chinese Patent Application No. 201410043332.8 filed on Jan. 29, 2014, the disclosure of which is incorporated herein by reference in its entirety as part of the present application.

1. A protective plate, comprising a translucent substrate, wherein a white shading frame, for covering a circuit layer, is provided in a periphery of the translucent substrate.

2. The protective plate according to claim 1, further comprising an optical transparent layer, which is arranged on the translucent substrate provided with the white shading frame, with a height of the optical transparent layer over the white shading frame less than a height of the optical transparent layer over the translucent substrate.

3. The protective plate according to claim 2, wherein
a thickness of the white shading frame is 5-20 μm;
the height of the optical transparent layer over the white shading frame is 1-5 μm;
the height of the optical transparent layer over the translucent substrate is 6-25 μm.

4. The protective plate according to claim 3, wherein
the thickness of the white shading frame is 8-12 μm;
the height of the optical transparent layer over the white shading frame is 1-3 μm;
the height of the optical transparent layer over the translucent substrate is 8-15 μm.

5. The protective plate according to claim 2, wherein the optical transparent layer is made of a translucent polymer material.

6. The protective plate according to claim 5, wherein the translucent polymer material is an optical clear resin.

7. The protective plate according to claim 2, wherein the white shading frame is made of an opaque polymer material.

8. The protective plate according to claim 7, wherein the opaque polymer material is white photosensitive ink.

9. The protective plate according to claim 1, wherein a groove is further provided in the periphery of the translucent substrate, and the white shading frame is arranged above the groove.

10. A display panel, comprising the protective plate according to claim 1.

11. A display device, comprising the display panel according to claim 10.

12. A preparation method of a protective plate, comprising:
providing a translucent substrate;
forming a white shading frame, for covering a circuit layer, in a periphery of the translucent substrate.

13. The preparation method of a protective plate according to claim 12, wherein after forming of a white shading frame in a periphery of the translucent substrate, the method further comprises:
forming an optical transparent layer on the translucent substrate provided with the white shading frame, with a height of the optical transparent layer over the white shading frame less than a height of the optical transparent layer over the translucent substrate.

14. The preparation method of a protective plate according to claim 13, wherein forming of a white shading frame in a periphery of the translucent substrate comprises:
forming a white shading frame in the periphery of the translucent substrate by screen printing, or by transferring or spin coating as well as exposing and developing;
forming of an optical transparent layer on the translucent substrate provided with the white shading frame comprises:
forming an optical transparent layer on the translucent substrate provided with the white shading frame by spin coating or blade coating.

15. The preparation method of a protective plate according to claim 12, wherein, after the providing a translucent substrate, the method further comprises: forming a groove in the periphery of the translucent substrate;
forming of a white shading frame in a periphery of the translucent substrate comprises: forming a white shading frame above the groove.

16. The protective plate according to claim 3, wherein the optical transparent layer is made of a translucent polymer material.

17. The protective plate according to claim 16, wherein the translucent polymer material is an optical clear resin.

18. The protective plate according to claim 3, wherein the white shading frame is made of an opaque polymer material.

19. The protective plate according to claim 18, wherein the opaque polymer material is white photosensitive ink.

20. The protective plate according to claim 2, wherein a groove is further provided in the periphery of the translucent substrate, and the white shading frame is arranged above the groove.
